(19) United States
(12) Patent Application Publication
(10) Pub. No.: US 2011/0128510 A1
(43) Pub. Date: Jun. 2, 2011

(54) PROJECTION IMAGE DISPLAY APPARATUS

(75) Inventors: Shinya MATSUMOTO, Uji-City (JP); Azusa TAKEUCHI, Moriguchi-City (JP); Makoto MAEDA, Osaka-City (JP)

(73) Assignee: SANYO ELECTRIC CO., LTD., Osaka (JP)

(21) Appl. No.: 12/956,530

(22) Filed: Nov. 30, 2010

(30) Foreign Application Priority Data
Nov. 30, 2009 (JP) 2009-272485
Mar. 29, 2010 (JP) 2010-075308
Oct. 5, 2010 (JP) 2010-225698

(51) Int. Cl. G03B 21/28; G03B 21/14

(52) U.S. Cl. 353/98; 353/119

(57) ABSTRACT

A projection display apparatus 100 includes a housing 200 configured to house an illumination optics 110 and a projection optics 120. The housing 200 includes a virtual cylindrical layout space 300 having as a base a circumscribed circle of the projection optics 120 in a cross-section perpendicular to an optical axis of the projection optics 120. The layout space 300 includes a first layout space 310 of approximately conical shape and a second layout space 320 left after excluding the first layout space 310. The projection optics 120 is provided in the first layout space 310. A specific optical element among optical elements included in the illumination optics 110 is provided in the second layout space 320.

### TECHNICAL FIELD

The present invention relates to a projection display apparatus including a solid light source, an imager configured to modulate the light emitted from the solid light source, and a projection optics configured to project the light incident from the imager onto a projection surface.

### BACKGROUND ART

Conventionally, a projection display apparatus having a projection optics which projects the light emitted from an illumination optics on a projection surface is known. The illumination optics includes, for example, a solid light source such as an LED (Light Emitting Diode), and an imager which modulates the light emitted from the solid light source.

There may be a projection display apparatus that the illumination optics and the projection optics are arranged so that the optical axis of the illumination optics is perpendicular to that of the projection optics (for example, see Japanese Patent Application Publication No. 2004-45718).

Meanwhile, there is a need for arranging the projection optics in the middle of the housing that houses the illumination optics and the projection optics. In addition, reduction of the size of the housing is also desired.

In a general projection display apparatus, the size of the housing that houses the illumination optics and the projection optics cannot be reduced because the optical axis of the illumination optics is perpendicular to that of the projection optics.

### SUMMARY OF THE INVENTION

A projection display apparatus of a first aspect includes a housing (housing 200) configured to house an illumination optics and a projection optics (projection optics 110). The housing includes a virtual cylindrical layout space (layout space 300) having as a base a circumscribed circle of the projection optics in a cross-section perpendicular to an optical axis of the projection optics. The layout space includes a first layout space (first layout space 310) of approximately conical shape and a second layout space (second layout space 320) left after excluding the first layout space. The projection optics is provided in the first layout space. A specific optical element among optical elements included in the illumination optics is provided in the second layout space.

In the first aspect, the specific optical element is an optical uniformizing element (rod integrator 20). An optical axis of the optical uniformizing element is parallel to an optical axis of the projection optics.

In the first aspect, the specific optical element is an optical uniformizing element (rod integrator 20). In a positional relationship, an optical axis of the optical uniformizing element is skewed toward an optical axis of the projection optics.

In the first aspect, the projection optics includes a first lens group (first projection lens group 111), a second lens group (second projection lens group 112) having a bigger diameter than the first lens group, and a reflection mirror (reflection mirror 113) configured to reflect a light incident from the second lens group toward a projection surface. Alight source (light source 10) included in the illumination optics is provided between the second lens group and the reflection mirror.

In the first aspect, a light source included in the illumination optics is provided at a side of the lens group provided in the projection optics.

A projection display apparatus of a second aspect includes a housing (housing 1200) configured to house an illumination optics (illumination optics 1120) and a projection optics (projection optics 1110). The illumination optics includes a light source (light source 1010), a mirror (turning mirror 1051) configured to reflect a light emitted from the light source, and an imager (DMD 1070) configured to modulate a light reflected by the mirror. The mirror is aligned with the projection optics in a horizontal direction approximately perpendicular to an optical axis of the projection optics. In the horizontal direction approximately perpendicular to the optical axis of the projection optics, a distance between an outermost end of the light source and the optical axis of the projection optics is approximately equal to a distance between an outermost end of the mirror and the optical axis of the projection optics.

In the second aspect, the projection optics includes a reflection mirror configured to reflect a light emitted from the illumination optics toward a projection area.

In the second aspect, the reflection mirror is a plane mirror or a concave mirror. The imager is arranged at a position shifted toward an opposite side of the optical axis of the projection optics from the projection area.

In the second aspect, the reflection mirror is a convex mirror. The imager is arranged at a position shifted toward an opposite side of the optical axis of the projection optics from the projection area.

In the second aspect, the reflection mirror is a concave mirror. The imager is arranged at a position shifted toward an opposite side of the optical axis of the projection optics from the projection area.

### BRIEF DESCRIPTION OF DRAWINGS

FIG. 1 is a diagram showing a projection display apparatus 100 according to a first embodiment.

FIG. 2 is a diagram showing the projection display apparatus 100 according to the first embodiment.

FIG. 3 is a diagram explaining a layout space according to the first embodiment.

FIG. 4 is a diagram showing a first arrangement example of optical elements according to the first embodiment.

FIG. 5 is a diagram showing the first arrangement example of the optical elements according to the first embodiment.

FIG. 6 is a diagram showing a second arrangement example of the optical elements according to the first embodiment.

FIG. 7 is a diagram showing the second arrangement example of the optical elements according to the first embodiment.

FIG. 8 is a diagram showing a third arrangement example of the optical elements according to the first embodiment.

FIG. 9 is a diagram showing the third arrangement example of the optical elements according to the first embodiment.

FIG. 10 is a diagram showing a configuration example of an illumination optics 510 according to Modification Example 1.

FIG. 11 is a diagram showing a first arrangement example of optical elements according to Modification Example 1.

FIG. 12 is a diagram showing a heat pipe 530 according to Modification Example 1.

FIG. 13 is a diagram showing a second arrangement example of the optical elements according to Modification Example 1.

FIG. 14 is a diagram showing a third arrangement example of the optical elements according to Modification Example 1.

FIG. 15 is a diagram showing a configuration example of the illumination optics 510 according to Modification Example 2.

FIG. 16 is a diagram showing the configuration example of the illumination optics 510 according to Modification Example 2.

FIG. 17 is a diagram showing a first arrangement example of optical elements according to Modification Example 2.

FIG. 18 is a diagram showing a second arrangement example of the optical elements according to Modification Example 2.

FIG. 19 is a diagram showing a third arrangement example of the optical elements according to Modification Example 2.

FIG. 20 is a diagram showing a configuration example of the illumination optics 510 according to Modification Example 3.

FIG. 21 is a diagram showing a schematic configuration of the projection display apparatus 100 according to a second embodiment.

FIG. 22 is a diagram showing a schematic configuration of the projection display apparatus 100 according to the second embodiment.

FIG. 23 is a diagram showing a schematic configuration of the projection display apparatus 100 according to the second embodiment.

FIG. 24 is a diagram showing an optical configuration of the projection display apparatus 100 according to the second embodiment.

FIG. 25 is a diagram showing the optical configuration of the projection display apparatus 100 according to the second embodiment.

FIG. 26 is a diagram showing an optical configuration of the projection display apparatus 100 according to Modification Example 1.

FIG. 27 is a diagram showing an optical configuration of the projection display apparatus 100 according to Modification Example 2.

FIG. 28 is a diagram showing an optical configuration of the projection display apparatus 100 according to Modification Example 3.

### EMBODIMENT FOR CARRYING OUT THE INVENTION

In the following, projection display apparatuses according to the embodiments of the present invention are described with reference to the drawings. Note that, in the following description of the drawings, same or similar reference signs denote same or similar elements and portions.

In addition, it should be noted that the drawings are schematic and ratios of dimensions and the like are different from actual ones. Therefore, specific dimensions and the like should be determined in consideration of the following description. Moreover, the drawings also include portions having different dimensional relationships and ratios from each other.

### Outline of First Embodiment

The projection display apparatus according to the first embodiment has a housing which houses an illumination optics and a projection optics. The housing has a virtual cylindrical layout space having as a base a circumscribed circle of the projection optics in a cross-section perpendicular to the optical axis of the projection optics. The layout space has a first layout space of approximately conical shape, and a second layout space left after excluding the first layout space. The projection optics is provided in the first layout space. Specific optical elements among the optical elements included in the illumination optics are provided in the second layout space.

According to the first embodiment, the projection optics is provided in the first layout space of approximately conical shape, and the specific optical elements are arranged in the dead space (the second layout space) created in the housing by arrangement of the projection optics. That is to say, the dead space is used effectively, and thus the illumination optics and the projection optics can be arranged in a space-saving manner. Also, the illumination optics and the projection optics can be arranged in approximately the middle in the width direction of the housing.

The specific optical elements are optical uniformizing elements such as a rod integrator and a fly-eye lens unit, a relay lens, a mirror, for example.

In the first embodiment, the specific optical elements included in the illumination optics are provided in the second layout space left after excluding the first layout space, where the projection optics is arranged, from the entire layout space. That is to say, the dead space (the second layout space) created due to an arrangement of the projection optics can be effectively used by arranging the specific optical elements therein.

### First Embodiment

### Configuration of Projection Display Apparatus

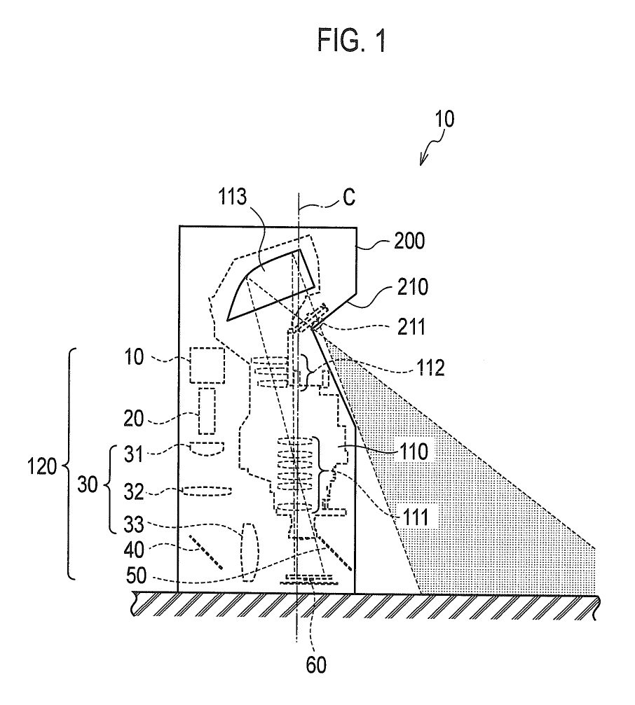

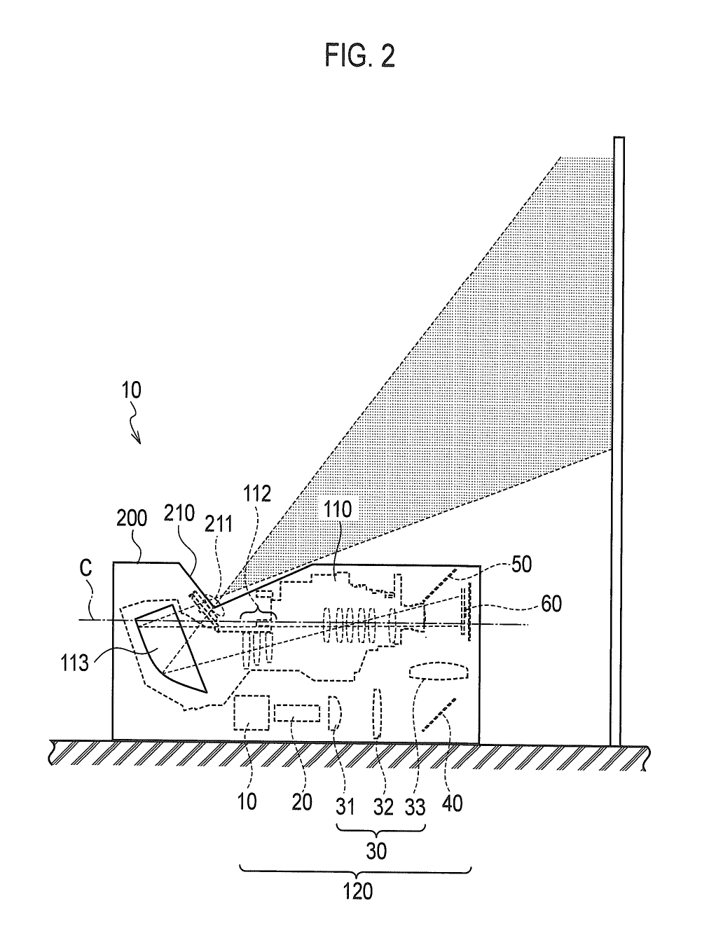

In the following, the configuration of the projection display apparatus according to the first embodiment is described with reference to the drawings. FIG. 1 is a diagram showing the projection display apparatus 100 (floor surface projection) according to the first embodiment. FIG. 2 is a diagram showing the projection display apparatus 100 (wall surface projection) according to the first embodiment.

As shown in FIGS. 1 and 2, the projection display apparatus 100 has a housing 200, and projects an image on a projection surface (not shown). As shown in FIG. 1, the projection surface may be provided on the floor surface, or may be provided on the wall surface as shown in FIG. 2.

Specifically, the projection display apparatus 100 includes a light source 10, a rod integrator 20, a lens group 30, a mirror 40, a mirror 50, a DMD 60, and a projection optics 110. These optical elements are housed in the housing 200.

The light source 10 is configured so as to emit multiple color component lights individually. For example, the light source 10 is formed of a light source 10R, a light source 10G and a light source 10B.

The light source lOR is the one that emits a red component light R, and, for example, is a red LED (Light Emitting Diode) or a red LD (Laser Diode). The light source 10G is the one that emits a green component light G, and, for example, is a green LED or a green LD. The light source 10B is the one that emits a blue component light B, and, for example, is a blue LED or a blue LD.

The rod integrator 20 has a light incident surface, a light exit surface, and a light reflection side surface provided all the way from the circumference of the light incident surface to that of the light exit surface. The rod integrator 20 uniformizes the color component light emitted from the light source 10. Specifically, the rod integrator 20 uniformizes the color component light by reflecting the same against the light reflection side surface. Here, the rod integrator 20 may be a filled rod composed of glass or may be a hollow rod whose inside is formed of mirror surfaces.

The lens group 30 is a relay lens that forms an approximate image of the color component light on the DMD 60, while suppressing expansion of the color component light emitted from the light source 10. The lens group 30 includes, for example, multiple lenses (a lens 31, a lens 32 and a lens 33).

The mirror 40 reflects the color component light incident from the lens group 30 toward the mirror 50. Specifically, the mirror 40 reflects the color component light to the perpendicular direction to an optical axis C of the projection optics 110. The mirror 50 reflects the color component light incident from the mirror 40 toward the DMD 60.

The DMD 60 is formed of multiple minute mirrors, which are movable. Each minute mirror basically corresponds to one pixel. The DMD 60 switches between reflection and non-reflection of the color component light so as to guide the color component light to the projection optics 110 as an effective light by changing the angle of each minute mirror.

It should be noted that the center of the DMD 60 is shifted from the optical axis C of the projection optics 110. Specifically, the center of the DMD 60 is shifted from the optical axis C of the projection optics 110 toward the projection surface.

It should be noted that the light source 10, the rod integrator 20, the lens group 30, the mirror 40, and the mirror 50 are included in the illumination optics.

The projection optics 110 projects the color component light (image light) reflected by the DMD 60 toward the projection surface. Specifically, the projection optics 110 includes a first projection lens group 111, a second projection lens group 112, and a reflection mirror 113.

The first projection lens group 111 guides the color component light (image light) reflected by the DMD 60 toward the second projection lens group 112. The first projection lens group 111 has an approximately circular shape with its center on the optical axis C of the projection optics 110.

The second projection lens group 112 guides the color component light (image light) incident from the first projection lens group 111 toward the reflection mirror 113. Here, the second projection lens group 112 has a shape formed by a portion of an approximately circular shape with its center on the optical axis C of the projection optics 110 (for example, a lower half semi-circle). It should be noted that the diameter of the second projection lens group 112 is greater than that of the first projection lens group 111.

The reflection mirror 113 reflects the color component light (image light) incident from the first projection lens group 111. The reflection mirror 113 collects the image light, and then enlarges the image light. For example, the reflection mirror 113 is a non-spherical mirror having its concave surface on a side closer to the first projection lens group 111. Here, the reflection mirror 113 has a shape formed by a portion of an approximately circular shape with its center on the optical axis C of the projection optics 110 (for example, a lower half semi-circle).

The image light collected by the reflection mirror 113 passes through a transmission area 211 provided on an inclined surface 210 of the housing 200. The transmission area 211 on the inclined surface 210 is preferably provided in the neighborhood of the position where the image light is collected by the reflection mirror 113.

It should be noted that the size of the housing 200 in the direction of the optical axis C of the projection optics 110 is determined by the arrangement of (the distance between) the DMD 60 and the reflection mirror 113.

### Layout Space

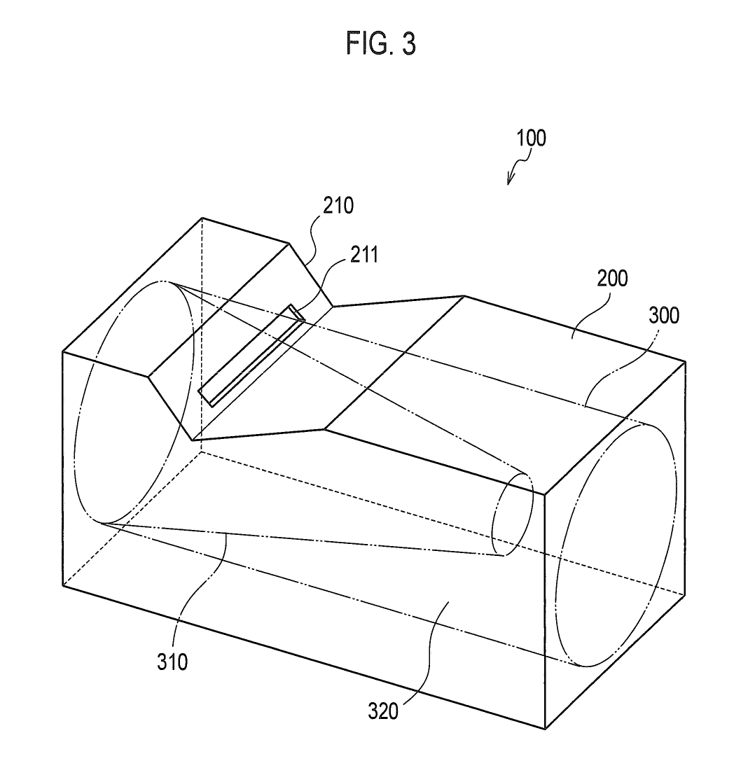

In the following, a layout space according to the first embodiment is described with reference to the drawings. FIG. 3 is a diagram illustrating a layout space 300 according to the first embodiment.

As shown in FIG. 3, the housing 200 has the layout space 300 which is defined by the first layout space 310 and the second layout space 320.

The layout space 300 has a virtual cylindrical shape having as the base a circumscribed circle of the projection optics 110 in a cross-section perpendicular to the optical axis of the projection optics 110. The base of the layout space 300 has its center on the optical axis C of the projection optics 110. The base of the layout space 300 is the circumscribed circle of the most outwardly protruded portion (for example, the reflection mirror 113) of the projection optics 110, in cross-sections perpendicular to the optical axis of the projection optics 110.

The first layout space 310 has an approximately conical shape. Specifically, the first layout space 310 has a flared shape from the DMD 60 to the reflection mirror 113.

The first layout space 310 is provided with the projection optics 110. The projection optics 110 may be arranged so that the entirety thereof is completely contained in the first layout space 310, or a portion thereof protrudes from the first layout space 310.

The second layout space 320 is the space left after excluding the first layout space 310 from the layout space 300. Cross-sectional volume of the second layout space 320 increases from the reflection mirror 113 to the DMD 60.

The second layout space 320 is provided with specific optical elements among the ones included in the illumination optics. The specific optical elements are, for example, the rod integrator 20, the lens group 30, the mirror 40, and the mirror 50. The specific optical elements preferably include at least the rod integrator 20.

The specific optical elements are preferably arranged so that the entirety thereof is contained in the second layout space 320. However, the specific optical elements may be arranged so that a portion thereof protrudes from the second layout space 320.

### First Arrangement Example

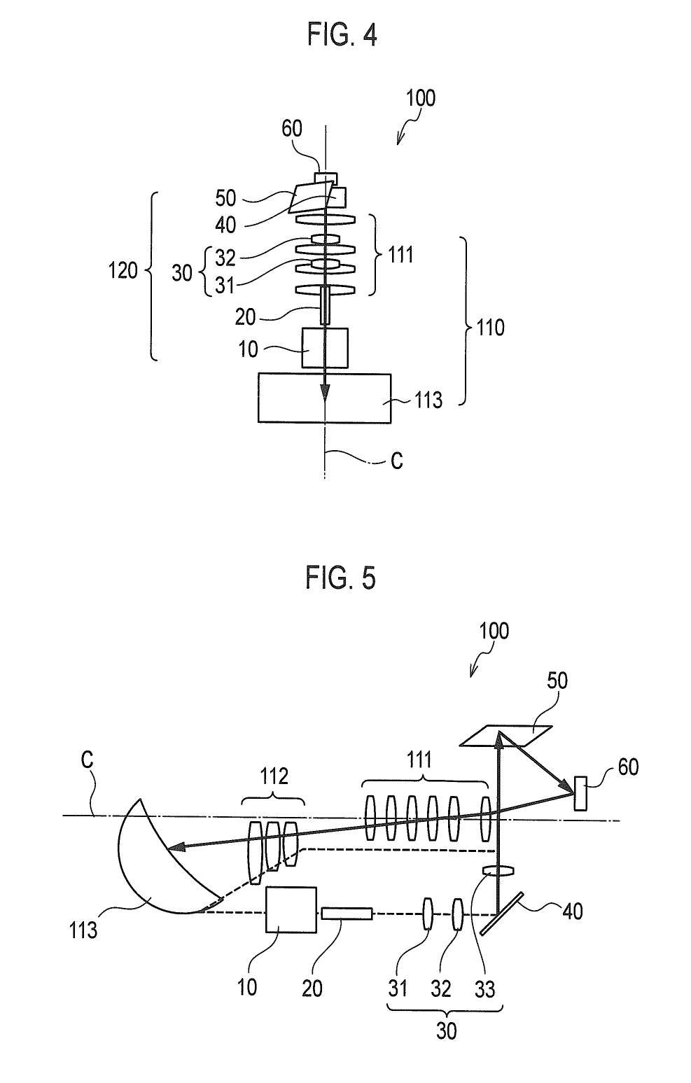

In the following, a first arrangement example according to the first embodiment is described with reference to the drawings. FIGS. 4 and 5 are diagrams showing the first arrangement example according to the first embodiment. Specifically, FIG. 4 is a top view of the inside of the projection display apparatus 100, and FIG. 5 is a side view of the same.

As shown in FIGS. 4 and 5, the light source 10 is arranged on the side of the projection optics 110. Also, the light source 10 is preferably arranged between the first projection lens group 111 and the reflection mirror 113. The light source 10 is arranged so as to emit a color component light in a direction approximately parallel to the optical axis C of the projection optics 110.

Since the light emission direction of the light source 10 is approximately parallel to the optical axis C of the projection optics 110 as such, so is the optical axis of the rod integrator 20.

### Second Arrangement Example

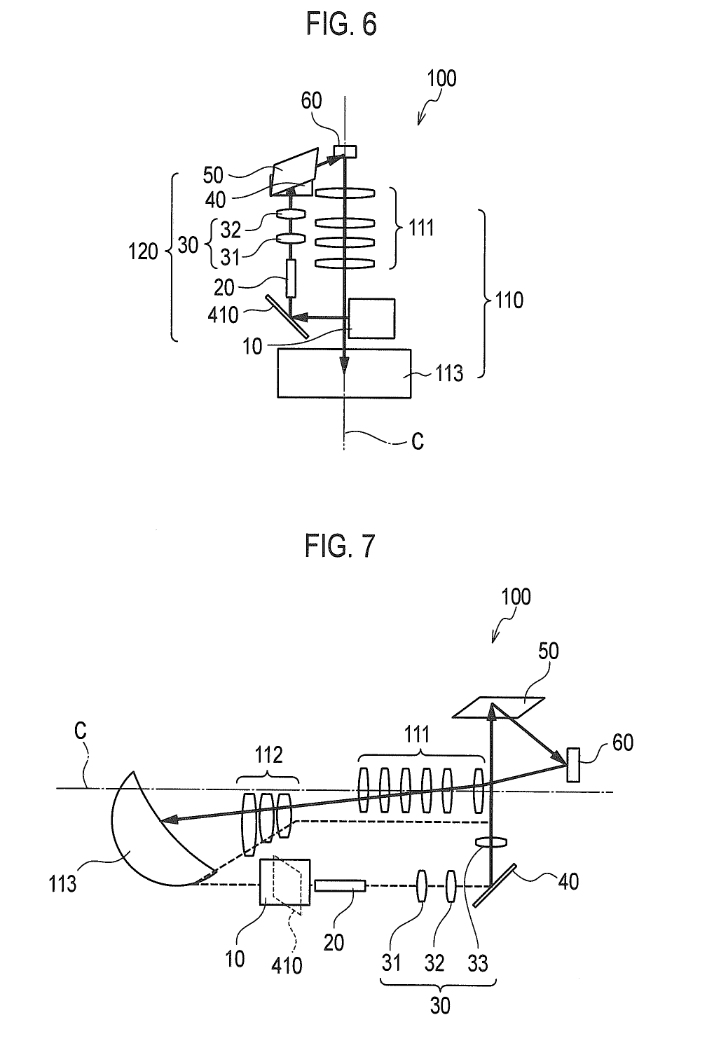

In the following, a second arrangement example according to the first embodiment is described with reference to the drawings. FIGS. 6 and 7 are diagrams showing the second arrangement example according to the first embodiment. Specifically, FIG. 6 is a top view of the inside of the projection display apparatus 100, and FIG. 7 is a side view of the same.

As shown in FIGS. 6 and 7, the light source 10 is arranged on the side of the projection optics 110. Also, the light source 10 is preferably arranged between the first projection lens group 111 and the reflection mirror 113. The light source 10 is arranged so as to emit a color component light in a direction approximately perpendicular to the optical axis C of the projection optics 110.

In the second arrangement example, a reflection mirror 410 is provided to reflect the color component light emitted from the light source 10. The reflection mirror 410 reflects the color component light emitted from the light source 10 in a direction approximately parallel to the optical axis C of the projection optics 110.

Since the light reflection direction of the reflection mirror 410 is approximately parallel to the optical axis C of the projection optics 110 as such, so is the optical axis of the rod integrator 20.

### Third Arrangement Example

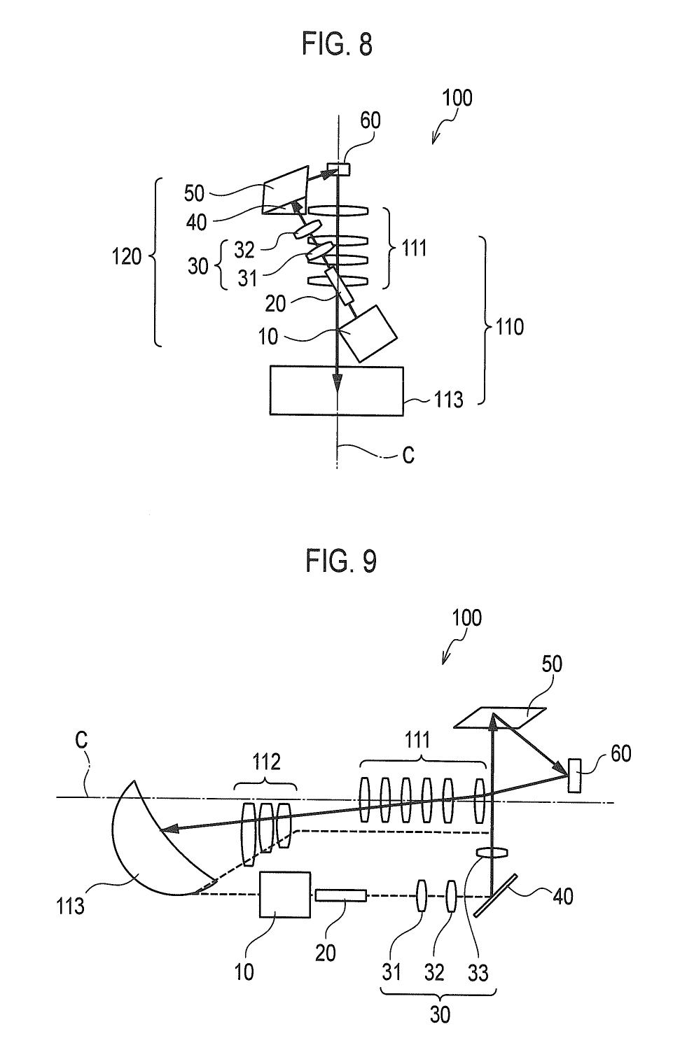

In the following, a third arrangement example according to the first embodiment is described with reference to the drawings. FIGS. 8 and 9 are diagrams showing the third arrangement example according to the first embodiment. Specifically, FIG. 8 is a top view of the inside of the projection display apparatus 100, and FIG. 9 is a side view of the same.

As shown in FIGS. 8 and 9, the light source 10 is arranged on the side of the projection optics 110. Also, the light source 10 is preferably arranged between the first projection lens group 111 and the reflection mirror 113. The light source 10 is arranged so as to emit a color component light in a direction inclined to the optical axis C of the projection optics 110.

Since the emission direction of the light source 10 is tilted with respect to the optical axis C of the projection optics 110 as such, so does the optical axis of the rod integrator 20.

Also, the color component light incident from the rod integrator 20 is reflected by the mirror 40 and the mirror 50 as described above. That is to say, in a positional relationship, the optical axis of the rod integrator 20 is skewed toward the optical axis C of the projection optics 110.

### Advantageous Effects

In the first embodiment, the specific optical elements (for example, the rod integrator 20) included in the illumination optics are provided in the second layout space 320 left after excluding the first layout space 310, where the projection optics 110 is arranged, from the layout space 300. That is to say, the dead space (the second layout space 320) created due to the arrangement of the projection optics 110 can be effectively used by arranging the specific optical elements therein. Also, the illumination optics and the projection optics 110 can be arranged in approximately the middle in a width direction of the housing 200.

In the second arrangement example (see FIGS. 6 and 7), the reflection mirror 410 to reflect the color component light emitted from the light source 10 is provided. Therefore, the second arrangement example can secure a long distance for the optical path of the color component light emitted from the light source 10 compared to the first arrangement example (see FIGS. 4 and 5).

Also, in the third arrangement example (see FIGS. 8 and 9), the emission direction of the light source 10 is tilted with respect to the optical axis C of the projection optics 110. That is to say, in a positional relationship, the optical axis of the rod integrator 20 is skewed toward the optical axis C of the projection optics 110. Therefore, the third arrangement example can secure a long distance for the optical path of the color component light emitted from the light source 10 compared to the first arrangement example (see FIGS. 4 and 5).

### Modification Example 1

In the following, Modification Example 1 of the first embodiment is described. In the following, the aspects of the Modification Example 1 which differ from those of the first embodiment are mainly described.

Although a case where a cooler such as a heat sink is provided has not been mentioned in the first embodiment, such case is illustrated in Modification Example 1.

### Configuration Example of Illumination Optics

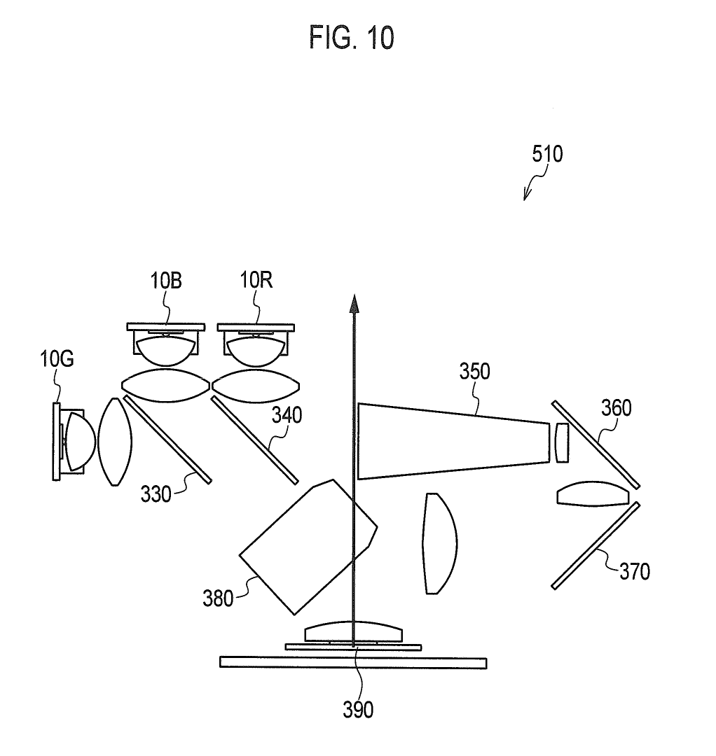

In the following, a configuration example of the illumination optics according to Modification Example 1 is described with reference to the drawings. FIG. 10 is a diagram showing a configuration example of an illumination optics 510 according to Modification Example 1.

As shown in FIG. 10, the illumination optics 510 includes a light source 10R, a light source 10G, a light source 10B, a dichroic mirror 330, a dichroic mirror 340, a rod integrator 350, a reflection mirror 360, a reflection mirror 370, a launch mirror 380, and a DMD 390. The illumination optics 510 may include or need not include the reflection mirror 360, the reflection mirror 370, the launch mirror 380, and the DMD 390. Needless to say, the illumination optics 510 includes required lens groups.

The dichroic mirror 330 transmits the green component light G emitted from the light source 10G, and reflects the blue component light B emitted from the light source 10B. The dichroic mirror 340 transmits the green component light G and the blue component light B, and reflects the red component light R emitted from the light source 10R.

Similarly to the rod integrator 20, the rod integrator 350 has a light incident surface, a light exit surface, and a light reflection side surface provided all the way from the circumference of the light incident surface to that of the light exit surface. The rod integrator 350 uniformizes the color component lights emitted from the light source 10 (the light sources 10R, 10G, and 10B).

The reflection mirrors 360 and 370 reflect the color component lights incident from the rod integrator 350, and guide the same to the launch mirror 380.

The launch mirror 380 reflects the color component lights guided by the reflection mirrors 360 and 370 toward the DMD 390.

Similarly to the DMD 60, the DMD 390 is formed of multiple minute mirrors, which are movable. The DMD 390 switches between reflection and non-reflection of the color component lights by changing the angle of each minute mirror.

### First Arrangement Example

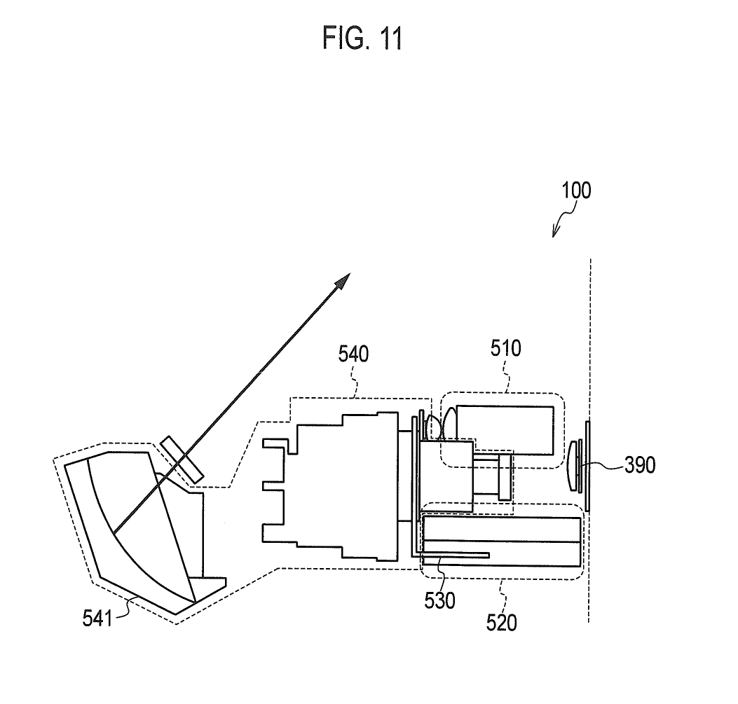

In the following, a first arrangement example according to Modification Example 1 is described with reference to the drawings. FIG. 11 is a diagram showing the first arrangement example according to Modification Example 1.

As shown in FIG. 11, the projection display apparatus 100 includes the illumination optics 510, a cooler 520, a heat pipe 530, and a projection optics 540.

As described above, the illumination optics 510 has the light source 10, the dichroic mirror 330, the dichroic mirror 340, and the rod integrator 350. In FIG. 11, it is assumed that the reflection mirror 360, the reflection mirror 370, the launch mirror 380, and the DMD 390 are not included in the illumination optics 510.

The cooler 520 has a function to cool a heat source (for example, the light source 10). For example, the cooler 520 is a heat dissipation member such as a heat sink.

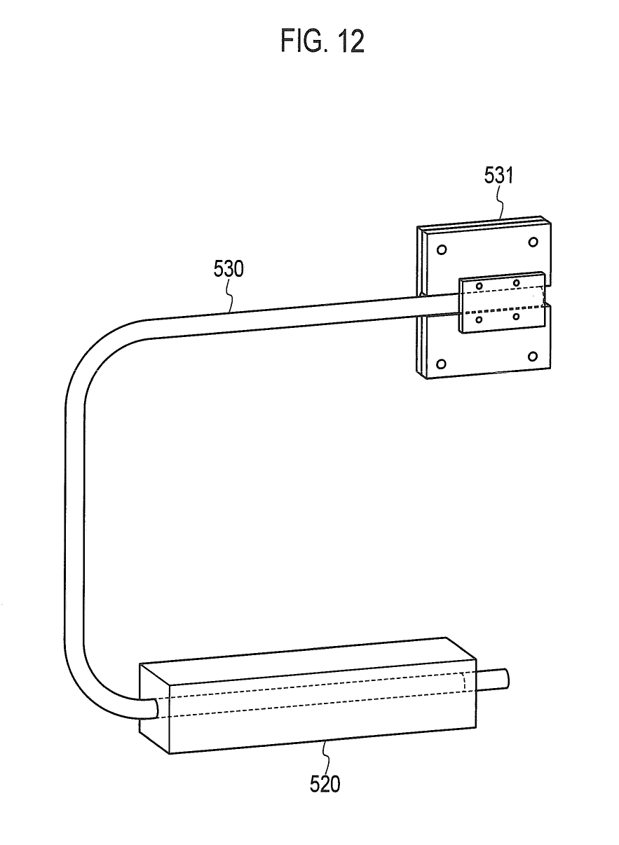

The heat pipe 530 is a pipe to conduct the heat produced by a heat source (for example, the light source 10) to the cooler 520. The heat pipe 530 is composed of a member having a high heat conductivity, such as copper. Specifically, as shown in FIG. 12, one end of the heat pipe 530 is connected to the cooler 520. On the other hand, the other end of the heat pipe 530 forms a heat receiver 531, which is connected to a heat source (for example, the light source 10).

Similarly to the projection optics 110, the projection optics 540 projects the color component light (image light) reflected by the DMD 390 toward the projection surface. For example, the projection optics 540 has a reflection mirror 541 in addition to multiple projection lens groups.

Similarly to the reflection mirror 113, the reflection mirror 541 reflects the color component light (image light) emitted from the illumination optics 510 toward the projection surface. The reflection mirror 541 is, for example, a non-spherical mirror having its concave surface on a side closer to the illumination optics 510.

In the first arrangement example of Modification Example 1, the illumination optics 510 is arranged on the opposite side of the projection optics 540 from the cooler 520. Specifically, the illumination optics 510 is arranged above the projection optics 540, and the cooler 520 is arranged below the projection optics 540.

At least a portion of the illumination optics 510 is preferably arranged in the second layout space 320 described above. Similarly, at least a portion of the cooler 520 is preferably arranged in the second layout space 320 described above.

### Second Arrangement Example

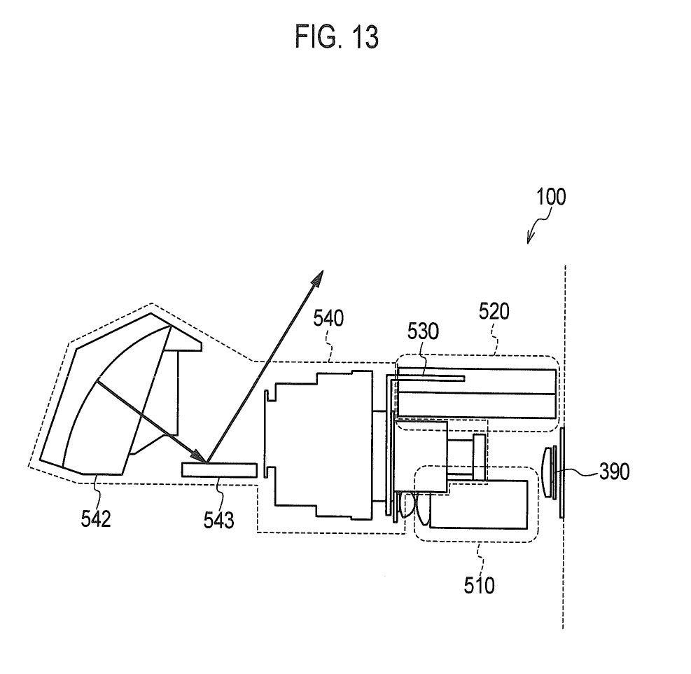

In the following, a second arrangement example according to Modification Example 1 is described with reference to the drawings. FIG. 13 is a diagram showing the second arrangement example according to Modification Example 1.

As shown in FIG. 13, the projection optics 540 has a reflection mirror 542 and a reflection mirror 543 instead of the reflection mirror 541.

The reflection mirror 542 reflects the color component light (image light) emitted from the illumination optics 510 toward the reflection mirror 543. The reflection mirror 542 is, for example, a non-spherical mirror having its concave surface on a side closer to the illumination optics 510. The reflection mirror 543 reflects the color component light (image light) reflected by the reflection mirror 542 toward the projection surface. The reflection mirror 543 is, for example, a plane mirror.

In the second arrangement example of Modification Example 1, the illumination optics 510 is arranged on the opposite side of the projection optics 540 from the cooler 520. Specifically, the illumination optics 510 is arranged below the projection optics 540, and the cooler 520 is arranged above the projection optics 540.

At least a portion of the illumination optics 510 is preferably arranged in the second layout space 320 described above. Similarly, at least a portion of the cooler 520 is preferably arranged in the second layout space 320 described above.

### Third Arrangement Example

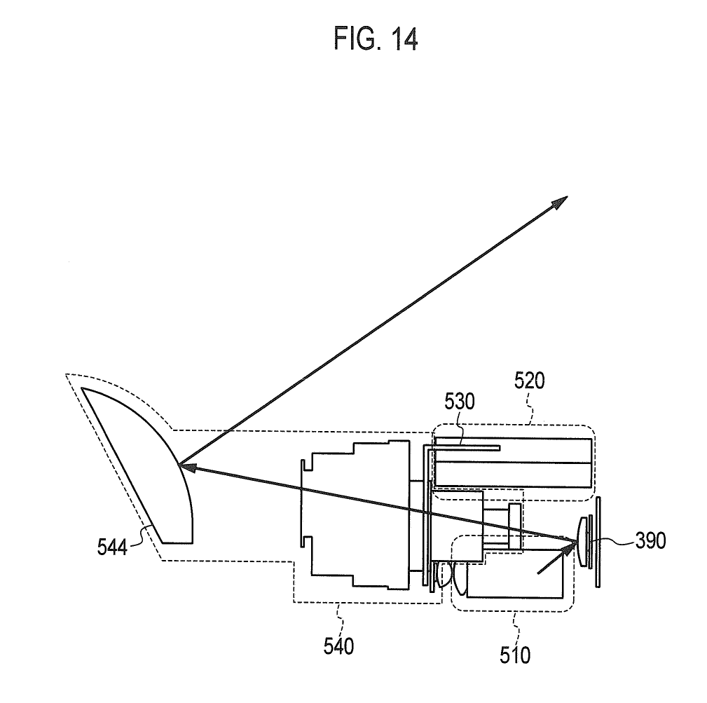

In the following, a third arrangement example according to Modification Example 1 is described with reference to the drawings. FIG. 14 is a diagram showing the third arrangement example according to Modification Example 1.

As shown in FIG. 14, the projection optics 540 has a reflection mirror 542 and a reflection mirror 544 instead of the reflection mirror 541.

The reflection mirror 544 reflects the color component light (image light) emitted from the illumination optics 510 toward the projection surface. The reflection mirror 542 is, for example, a non-spherical mirror having its convex surface on a side closer to the illumination optics 510.

In the third arrangement example of Modification Example 1, the illumination optics 510 is arranged on the opposite side of the projection optics 540 from the cooler 520. Specifically, the illumination optics 510 is arranged below the projection optics 540, and the cooler 520 is arranged above the projection optics 540.

At least a portion of the illumination optics 510 is preferably arranged in the second layout space 320 described above. Similarly, at least a portion of the cooler 520 is preferably arranged in the second layout space 320 described above.

### Modification Example 2

In the following, Modification Example 2 of the first embodiment is described. In the following, the aspects of the Modification Example 2 which differ from those of the first embodiment are mainly described.

In the first embodiment, a case where a DMD is used as an imager has been illustrated. Also, in the first embodiment, a case where a rod integrator is used as an optical uniformizing element has been illustrated.

On the other hand, in Modification Example 2, a case where three liquid crystal panels are used as imagers is illustrated. Also in Modification Example 2, a case where a fly-eye lens unit is used as an optical uniformizing element is illustrated.

### Configuration Example of Illumination Optics

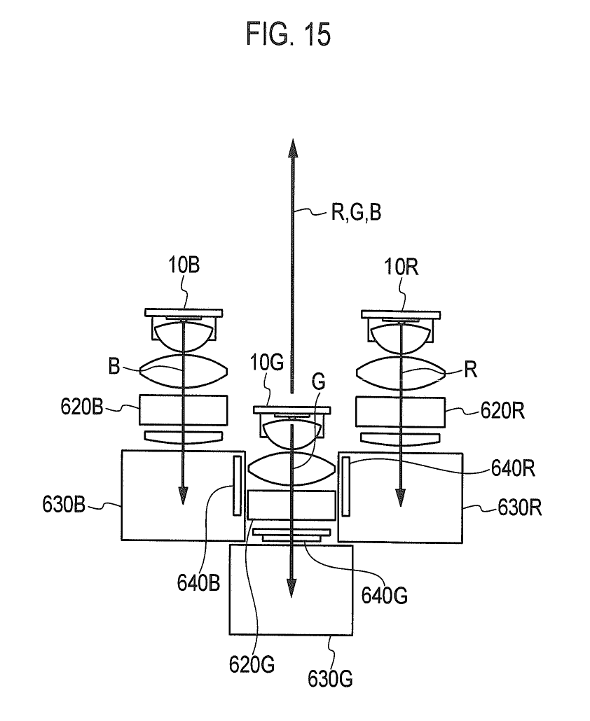

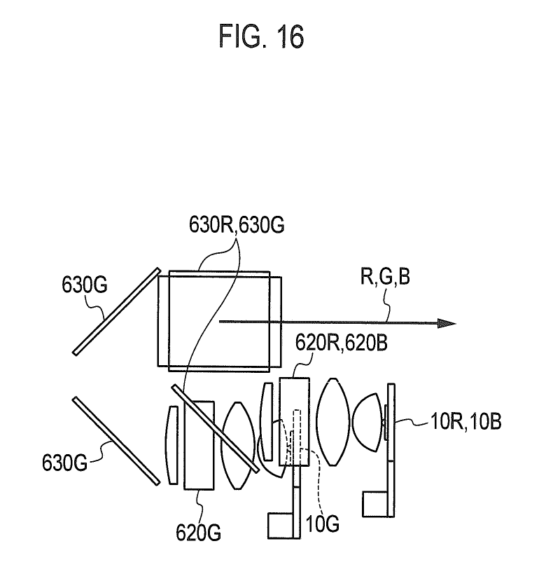

In the following, a configuration example of the illumination optics according to Modification Example 2 is described with reference to the drawings. FIGS. 15 and 16 are diagrams showing a configuration example of the illumination optics 510 according to Modification Example 2. FIG. 15 is a top view of the illumination optics 510, and FIG. 16 is a side view of the same.

As shown in FIGS. 15 and 16, the illumination optics 510 includes multiple light sources, multiple fly-eye lens units 620, multiple launch mirrors 630, and multiple liquid crystal panels 640. The illumination optics 510 may include or need not include the launch mirrors 630, the liquid crystal panels 640. Needless to say, the illumination optics 510 includes required lens groups.

Multiple light sources 10 include the light source 10R, the light source 10G, and the light source 10B.

Multiple fly-eye lens units 620 include a fly-eye lens unit 620R, a fly-eye lens unit 620G, and a fly-eye lens unit 620B.

Each fly-eye lens unit 620 includes multiple minute lenses, and each minute lens collects the color component light emitted from each light source 10 so that the color component light is radiated over the entire surface of each liquid crystal panel 640. Thereby, each fly-eye lens unit 620 uniformizes the color component light emitted from each light source 10.

Multiple launch mirrors 630 include a launch mirror 630R, a launch mirror 630G, and a launch mirror 630B.

Each launch mirror 630 reflects the color component light incident from each fly-eye lens unit 620, and guides the color component light toward each liquid crystal panel 640.

Multiple liquid crystal panels 640 include a liquid crystal panel 640R, a liquid crystal panel 640G, and a liquid crystal panel 640B.

Each liquid crystal panel 640 modulates the color component light guided by each launch mirror 630. The light incident surface and the light exit surface of the liquid crystal panel 640 are provided with a polarizing plate which transmits the light having a specific polarization direction, and shields the light having a polarization direction perpendicular to the specific polarization direction.

It should be noted that a dichroic prism which combines the lights incident from multiple liquid crystal panels 640 is provided though not so shown in FIGS. 15 and 16.

### Second Arrangement Example

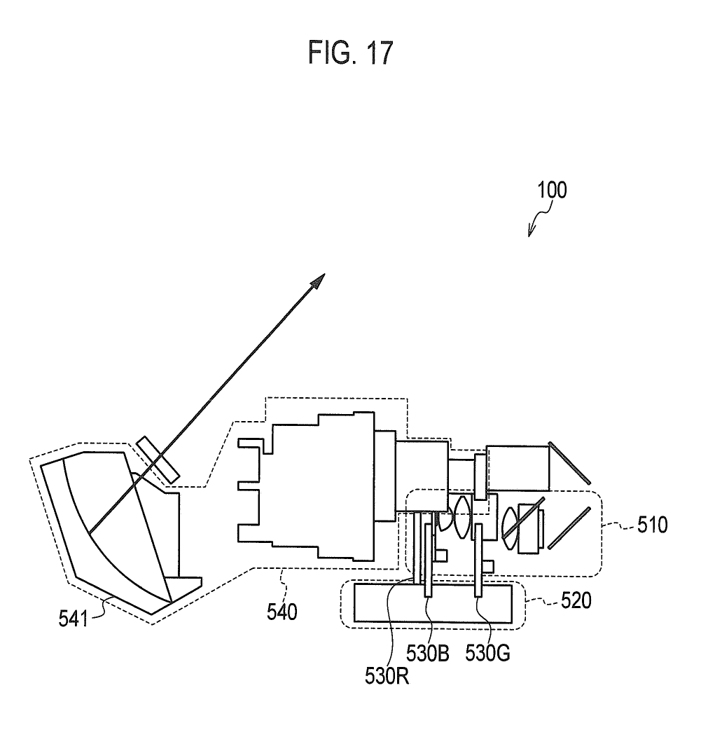

In the following, a first arrangement example according to Modification Example 2 is described with reference to the drawings. FIG. 17 is a diagram showing the first arrangement example according to Modification Example 2.

As shown in FIG. 17, the projection display apparatus 100 includes the illumination optics 510, a cooler 520, a heat pipe 530, and a projection optics 540. Here, the aspects of the first arrangement example of Modification Example 2 which differ from those of the first arrangement example of Modification Example 1 are mainly described.

The heat pipe 530 includes a heat pipe 530R, a heat pipe 530G, and a heat pipe 530B. The heat pipe 530R is a pipe to conduct the heat produced by the light source lOR to the cooler 520. Similarly, the heat pipes 530G and 530B are pipes to conduct the heat produced by the light sources 10G and 10B to the cooler 520, respectively.

In the first arrangement example of Modification Example 2, as shown in FIG. 17, the illumination optics 510 is arranged on the same side of the projection optics 540 as the cooler 520. Specifically, the illumination optics 510 is arranged below the projection optics 540, and the cooler 520 is arranged further below the illumination optics 510.

At least a portion of the illumination optics 510 is preferably arranged in the second layout space 320 described above. Similarly, at least a portion of the cooler 520 is preferably arranged in the second layout space 320 described above.

### Second Arrangement Example

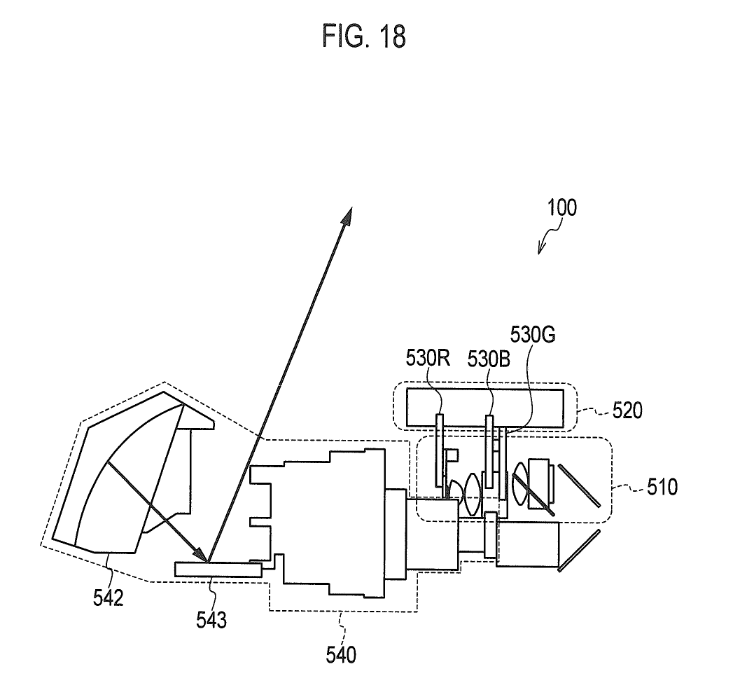

In the following, a second arrangement example according to Modification Example 1 is described with reference to the drawings. FIG. 18 is a diagram showing the second arrangement example according to Modification Example 2. Here, the aspects of the second arrangement example of Modification Example 2 which differ from those of the second arrangement example of Modification Example 1 are mainly described.

In the second arrangement example of Modification Example 2, as shown in FIG. 18, the illumination optics 510 is arranged on the same side of the projection optics 540 as the cooler 520. Specifically, the illumination optics 510 is arranged above the projection optics 540, and the cooler 520 is arranged further above the illumination optics 510.

At least a portion of the illumination optics 510 is preferably arranged in the second layout space 320 described above. Similarly, at least a portion of the cooler 520 is preferably arranged in the second layout space 320 described above.

### Third Arrangement Example

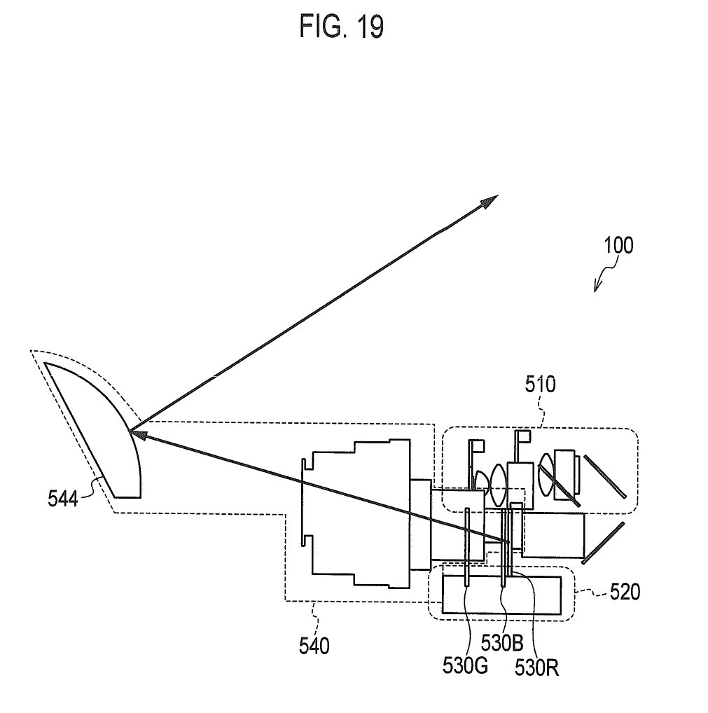

In the following, a third arrangement example according to Modification Example 2 is described with reference to the drawings. FIG. 19 is a diagram showing the third arrangement example according to Modification Example 2. Here, the aspects of the third arrangement example of Modification Example 2 which differ from those of the third arrangement example of Modification Example 1 are mainly described.

In the third arrangement example of Modification Example 2, as shown in FIG. 19, the illumination optics 510 is arranged on the opposite side of the projection optics 540 from the cooler 520. Specifically, the illumination optics 510 is arranged above the projection optics 540, and the cooler 520 is arranged below the projection optics 540.

At least a portion of the illumination optics 510 is preferably arranged in the second layout space 320 described above. Similarly, at least a portion of the cooler 520 is preferably arranged in the second layout space 320 described above.

### Modification Example 3

In the following, Modification Example 3 of the first embodiment is described. In the following, the aspects of the Modification Example 3 which differ from those of the first embodiment are mainly described.

In the first embodiment, a case where a rod integrator is used as an optical uniformizing element has been illustrated. On the other hand, in Modification Example 3, a case where a fly-eye lens unit is used as an optical uniformizing element is illustrated.

### Configuration Example of Illumination Optics

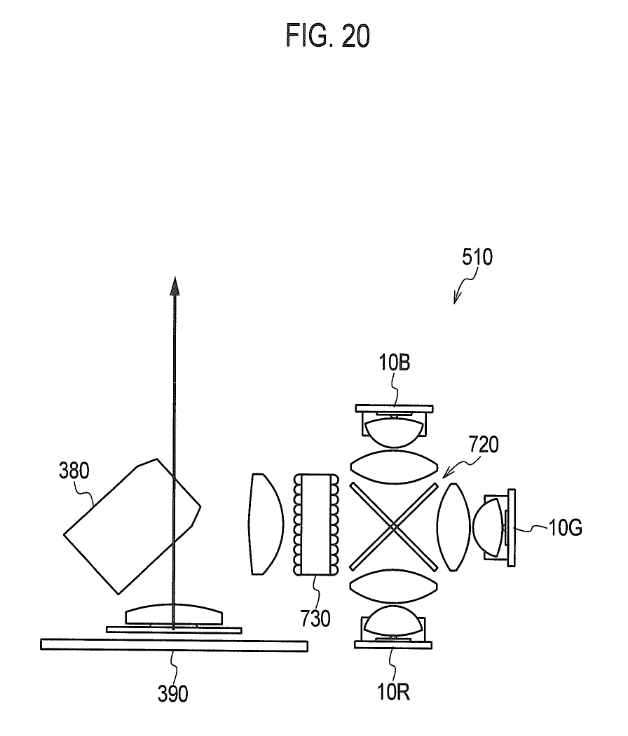

In the following, a configuration example of the illumination optics according to Modification Example 3 is described with reference to the drawings. FIG. 20 is a diagram showing a configuration example of an illumination optics 510 according to Modification Example 3. In FIG. 20, similar components to those in FIG. 10 are labeled with the same reference numerals as in FIG. 10.

As shown in FIG. 20, the illumination optics 510 has a cross dichroic mirror 720 instead of the dichroic mirror 330 and the dichroic mirror 340, and has a fly-eye lens unit 730 instead of the rod integrator 350.

The cross dichroic mirror 720 has a reflection surface which transmits the green component light G emitted from the light source 10G and the red component light R and reflects the blue component light B emitted from the light source 10B, and another reflection surface which transmits the green component light G and the blue component light B and reflects the red component light R emitted from the light source 10R.

The fly-eye lens unit 730 includes multiple minute lenses, and each minute lens collects the color component light emitted from each light source 10 so that the color component light is radiated over the entire surface of the DMD 390. Thereby, the fly-eye lens unit 730 uniformizes the color component light emitted from each light source 10.

### Outline of Second Embodiment

The projection display apparatus according to the second embodiment has a housing which houses an illumination optics and a projection optics. The illumination optics includes a light source, a mirror which reflects the light emitted from the light source, and an imager which modulates the light reflected by the mirror. The mirror is aligned with the projection optics in a horizontal direction approximately perpendicular to the optical axis of the projection optics. In a horizontal direction approximately perpendicular to the optical axis of the projection optics, the distance between the outermost end of the light source and the optical axis of the projection optics is approximately the same as that between the outermost end of the mirror and the optical axis of the projection optics.

In the second embodiment, the mirror is aligned with the projection optics in a horizontal direction approximately perpendicular to the optical axis of the projection optics. Therefore, in a horizontal direction approximately perpendicular to the optical axis of the projection optics, the distance between the outermost end of the light source and the optical axis of the projection optics can be made approximately the same as that between the outermost end of the mirror and the optical axis of the projection optics. In other words, the projection optics can be arranged in approximately the middle of the housing in a horizontal direction approximately perpendicular to the optical axis of the projection optics.

### Second Embodiment

### Schematic Configuration of Projection Display Apparatus

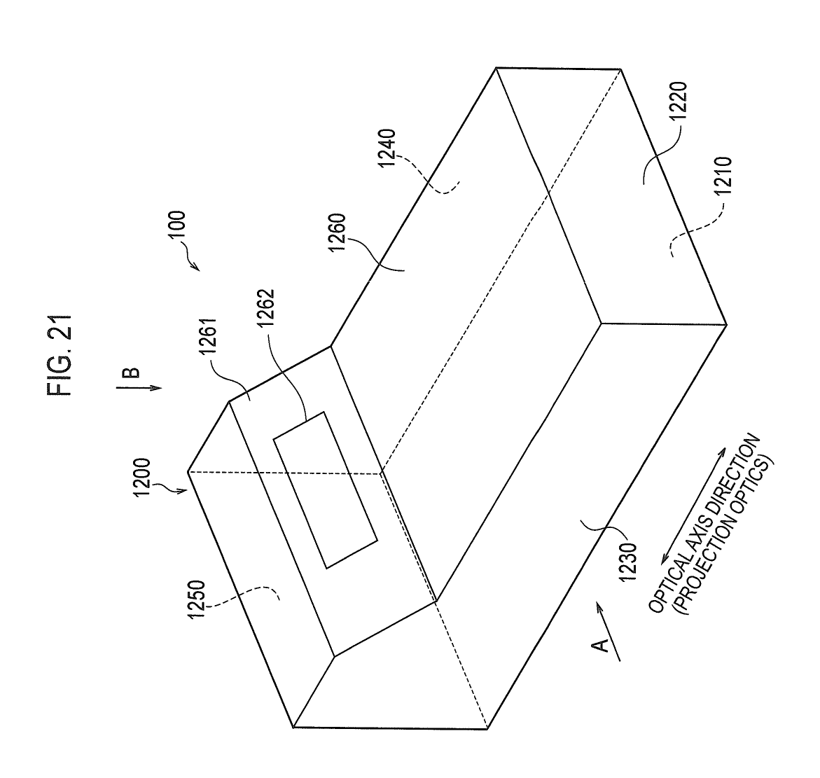

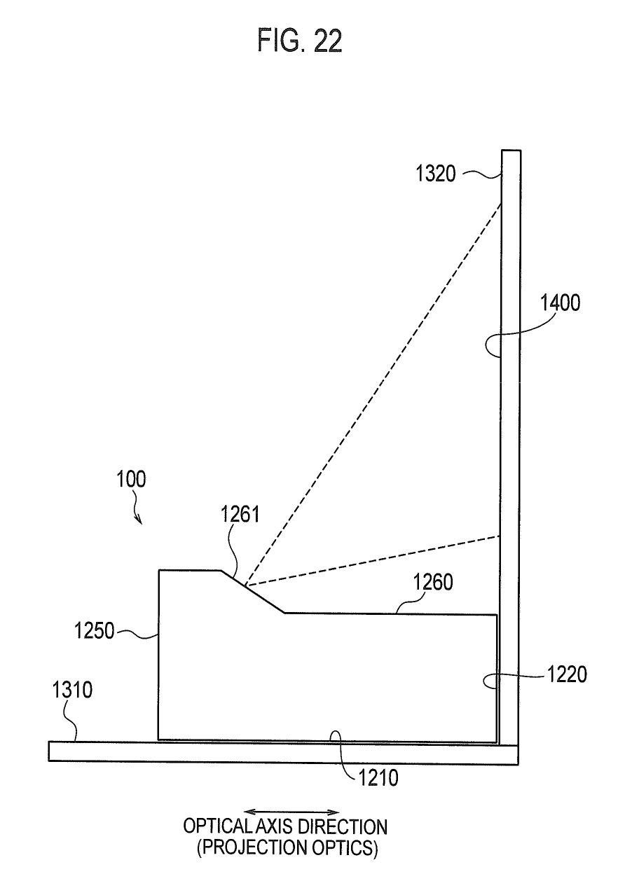

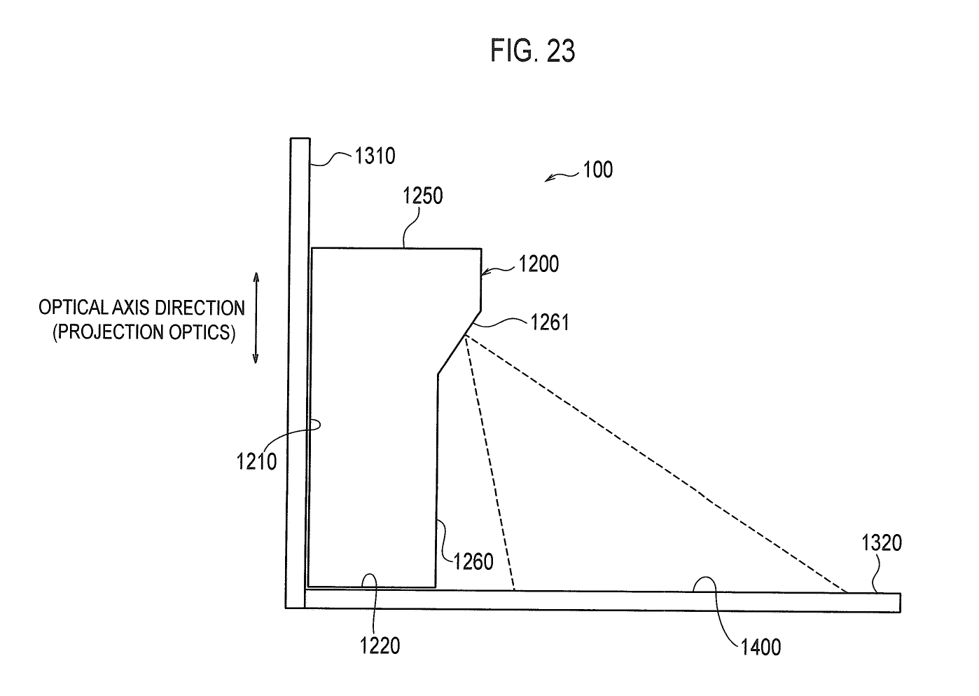

In the following, the schematic configuration of the projection display apparatus according to the second embodiment is described with reference to the drawings. FIG. 21 is a perspective view showing the schematic configuration of the projection display apparatus 100 according to the second embodiment. FIG. 22 is a diagram showing the projection display apparatus 100 (wall surface projection) according to the second embodiment. FIG. 23 is a diagram showing the projection display apparatus 100 (floor surface projection) according to the second embodiment.

As shown in FIGS. 21 to 23, the projection display apparatus 100 has a housing 1200, and projects an image on a projection area 1400 (not shown). As shown in FIG. 22, the projection area may be provided on the wall surface, or may be provided on the floor surface as shown in FIG. 23.

Here, as shown in FIG. 22, the projection display apparatus 100 is arranged on a first reference surface 1310 (floor surface). That is to say, the projection display apparatus 100 is arranged along the first reference surface 1310 (floor). In the case shown in FIG. 22, the projection display apparatus 100 projects an image light on the projection area 1400 (for example, screen) provided on a second reference surface 1320 (wall surface). In FIG. 23, the projection display apparatus 100 is arranged along the second reference surface 1320 (wall surface); however, need not be so arranged

Otherwise, the projection display apparatus 100 is arranged on the second reference surface 1320 (floor surface) as shown in FIG. 23. That is to say, the projection display apparatus 100 is arranged along the second reference surface 1320 (floor surface). In the case shown in FIG. 23, the projection display apparatus 100 projects an image light on the projection area 1400 provided on the second reference surface 1320 (floor surface). In FIG. 23, the projection display apparatus 100 is arranged along the first reference surface 1310 (wall surface); however, need not be so arranged.

The first reference surface 1310 is approximately parallel to the optical axis of the projection optics described later (the optical axis direction) when the projection display apparatus 100 is viewed from its side surface (the direction A shown in FIG. 21). The second reference surface 1320 is approximately perpendicular to the optical axis of the projection optics described later (the optical axis direction) when the projection display apparatus 100 is viewed from its side surface (the direction A shown in FIG. 21).

As shown in FIGS. 21 to 23, the housing 1200 includes a first opposed wall 1210, a second opposed wall 1220, a first sidewall 1230, a second sidewall 1240, a third sidewall 1250, and a top plate 1260.

The first opposed wall 1210 is opposed to the first reference surface 1310. For example, in the case shown in FIG. 22 (wall surface projection), the first opposed wall 1210 forms a base plate.

The second opposed wall 1220 is opposed to the second reference surface 1320. For example, in the case shown in FIG. 23 (floor surface projection), the second opposed wall 1220 forms a base plate.

The first sidewall 1230 and the second sidewall 1240 form the side surfaces of the housing 1200. The third sidewall 1250 forms the side surface of the housing 1200 provided on the opposite side to the second opposed wall 1220.

The top plate 1260 forms the side surface of the housing 1200 provided on the opposite side to the first opposed wall 1210. Here, the top plate 1260 has an inclined plane 1261, which is inclined toward the projection area 1400. The inclined plane 1261 has a transmission area 1262, which transmits (projects) the light incident from the projection display apparatus 100 toward the projection area 1400.

### Optical Configuration of the Projection Display Apparatus

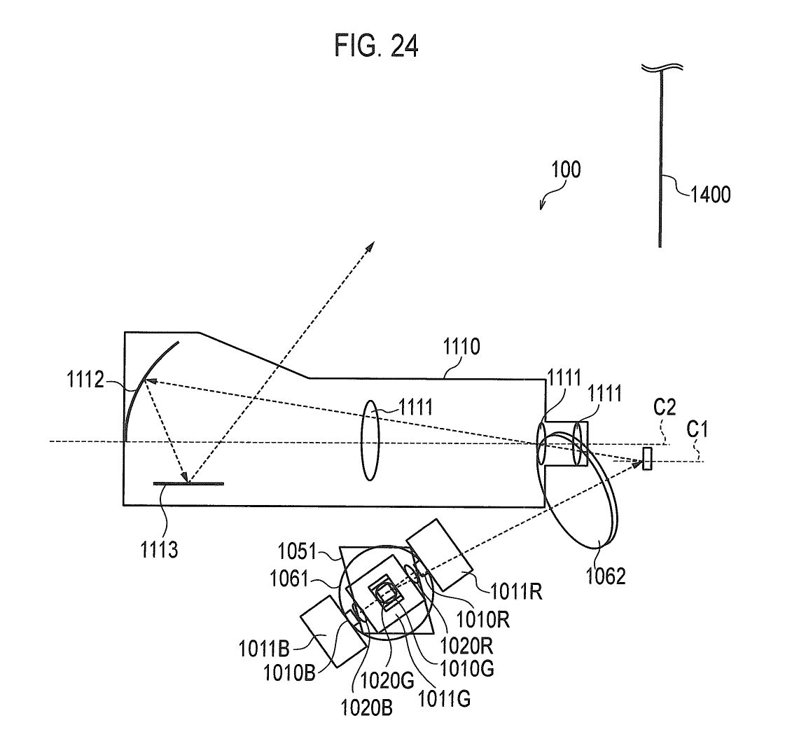

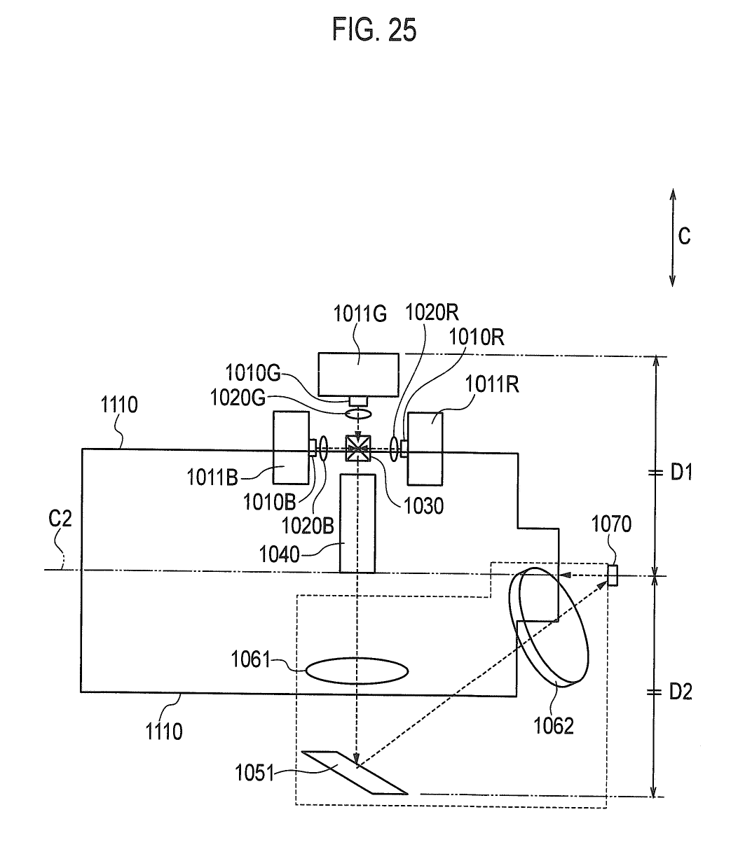

In the following, the optical configuration of a projection display apparatus according to the second embodiment is described with reference to the drawings. FIGS. 24 and 25 are diagrams showing the optical configuration of the projection display apparatus 100 according to the second embodiment. FIG. 24 is a diagram of the projection display apparatus 100 as viewed from the direction A shown in FIG. 21. FIG. 25 is a diagram of the projection display apparatus 100 as viewed from the direction B shown in FIG. 21. It should be noted that the housing 1200 is not shown in FIGS. 24 and 25.

As shown in FIGS. 24 and 25, the projection display apparatus 100 has a light source 1010 (a light source 1010R, a light source 1010G, and a light source 1010B), a lens group 1020 (a lens 1020R, a lens 1020G, a lens 1020B), a dichroic prism 1030, a rod integrator 1040, a turning mirror 1051, a lens 1061, a lens 1062, a DMD 1070, and a projection optics 1110. These optical elements are housed in the housing 1200.

The light source 1010 is configured to emit each color component light individually from multiple colors. Also, the light source 1010 is provided with a heat sink 1011 which dissipates the heat produced by the light source 1010. The light source 1010 is formed, for example, of the light source 1010R, the light source 1010G and the light source 1010B.

The light source 1010R is the one that emits the red component light R, and is, for example, a red LED (Light Emitting Diode) or a red LD (Laser Diode). The light source 1010R is provided with a heat sink 1011R formed of a member with a high heat dissipation, such as a metal.

The light source 1010G is the one that emits the green component light G, and is, for example, a green LED or a green LD. The light source 1010G is provided with a heat sink 1011G formed of a member with a high heat dissipation, such as a metal.

The light source 1010B is the one that emits the blue component light B, and is, for example, a blue LED or a blue LD. The light source 1010B is provided with a heat sink 1011B composed of a member with a high heat dissipation, such as a metal.

In the second embodiment, as shown in FIG. 24, the light source 1010 is arranged on the first opposed wall 1210 side of the optical axis center C₂ of the projection optics 1110f (the opposite side of the projection optics 1110 from the projection area 1400).

The lens 1020R is the one that collects the red component light R emitted from the light source 1010R. The lens 1020G is the one that collects the green component light G emitted from the light source 1010G. The lens 1020B is the one that collects the blue component light B emitted from the light source 1010B. Each of the lens 1020R, the lens 1020G, and the lens 1020B collects its own color component light so that the color component light is radiated over the effective area DMD 1070 described later. Also, each of the lens 1020R, the lens 1020G, and the lens 1020B may be formed of a single lens or multiple lenses.

The dichroic prism 1030 combines the red component light R collected by the lens 1020R, the green component light G collected by the lens 1020G, and the blue component light B collected by the lens 1020B.

The rod integrator 1040 has a light incident surface, a light exit surface, and a light reflection side surface provided all the way from the circumference of the light incident surface to that of the light exit surface. The rod integrator 1040 uniformizes the color component light incident from the dichroic prism 1030. Specifically, the rod integrator 1040 uniformizes the color component light by reflecting the same against the light reflection side surface. Here, the rod integrator 1040 may be a filled rod composed of glass or may be a hollow rod whose inside is formed of mirror surfaces.

For example, in the second embodiment, the rod integrator 1040 has a tapered shape having an increasing cross-section in the traveling direction of the light emitted from the light source 1010, the cross-section being perpendicular to the traveling direction. However, the embodiment is not limited to this case. The rod integrator 1040 may have a reverse-tapered shape having a decreasing cross-section in the traveling direction of the light emitted from the light source 1010, the cross-section being perpendicular to the traveling direction.

Also, in the second embodiment, the rod integrator 1040 has a rectangular cross-section perpendicular to the traveling direction of the light emitted from the light source 1010. For example, each cross-section of the rod integrator 1040 has a shape similar to the effective area of the DMD 1070. Needles to say, the cross-section of the rod integrator 1040 includes a light incident surface and a light exit surface.

The turning mirror 1051 is a reflection mirror that turns back the optical path of the light incident from the rod integrator 1040 so as to guide the light to the DMD 1070. Specifically, the turning mirror 1051 reflects the light incident from the rod integrator 1040 toward the DMD 1070.

The lenses 1061 and 1062 are relay lenses that form an approximate image of the color component light on the DMD 1070, while suppressing expansion of the color component light emitted from the light source 1010.

The DMD 1070 are formed of multiple minute mirrors, which are movable. Each minute mirror basically corresponds to one pixel. The DMD 1070 switches between reflection and non-reflection of the color component light so as to guide the color component light to the projection optics 1110 as an effective light by changing the angle of each minute mirror.

It should be noted that the center of the DMD 1070 is shifted from the optical axis of the projection optics 1110 (i.e., the center of the lenses provided in the projection optics 1110). Specifically, as shown in FIG. 24, the center C₁ of the DMD 1070 is shifted from the optical axis center C₂ of the projection optics 1110 toward the first opposed wall 1210 (the opposite side of the projection optics 1110 from the projection area 1400).

Also, the shift distance (C₂-C₁) of the DMD 1070 varies depending on the configuration of the projection optics 1110 described later. Also, the shift direction of the DMD 1070 varies depending on the arrangement of the light source 1010, or the configuration of the projection optics 1110

It should be noted here that the light source 1010, the lens group 1020, the dichroic prism 1030, the rod integrator 1040, the turning mirror 1051, the lens 1061, and the lens 1062 are included in the illumination optics 1120.

The projection optics 1110 projects the color component light (image light) incident from the DMD 1070 to the projection area 1400. Specifically, the projection optics 1110 includes a projection lens group 1111, a reflection mirror 1112, and a reflection mirror 1113.

The projection lens group 1111 guides the color component light (image light) incident from the DMD 1070 toward the reflection mirror 1112. The projection lens group 1111 includes a lens of an approximately circular shape having its center on the optical axis of the projection optics 1110, and a lens of a shape formed by a portion of an approximately circular shape having its center on the optical axis of the projection optics 1110 (for example, a lower half semi-circle).

It should be noted that among the lenses included in the projection lens group 1111, the one closer to the reflection mirror 1112 has a bigger diameter.

The reflection mirror 1112 reflects the color component light (image lights) incident from the projection lens group 1111. The reflection mirror 1112 collects the image light, and then enlarges the image light. For example, the reflection mirror 1112 is a non-spherical mirror having its concave surface on a side closer to the projection lens group 1111. Here, the reflection mirror 1112 has a shape formed by a portion of an approximately circular shape with its center on the optical axis C₂ of the projection optics 1110 (for example, an upper half semi-circle).

The reflection mirror 1113 reflects the image light reflected by the reflection mirror 1112 toward the projection area 1400. For example, the reflection mirror 1113 is a plane mirror.

The image light collected by the reflection mirror 1112 is reflected on the reflection mirror 1113, and passes through the transmission area 1262 provided on the inclined plane 1261 of the housing 1200. The transmission area 1262 on the inclined plane 1261 is preferably provided in the neighborhood of the position where the image light is roughly collected by the reflection mirror 1112. Also, a configuration may be such that the light collected by the projection lens group 1111 is reflected by the reflection mirror 1112.

It should be noted that the size of the housing 1200 in the direction of the optical axis of the projection optics 1110 is determined by the arrangement of (the distance between) the projection area 1400 and the reflection mirror 1112.

In the second embodiment, as shown in FIG. 25, the light source 1010 is aligned with the projection optics 1110 in a horizontal direction (direction C shown in FIG. 25) approximately perpendicular to the optical axis C₂ of the projection optics 1110. The turning mirror 1051 is aligned with the projection optics 1110 in a horizontal direction (the direction C shown in FIG. 25) approximately perpendicular to the optical axis C₂ of the projection optics 1110. The turning mirror 1051 is arranged on the opposite side of the optical axis C₂ of the projection optics 1110 from the light source 1010.

In a horizontal direction (the direction C shown in FIG. 25) approximately perpendicular to the optical axis C₂ of the projection optics 1110, the distance between the outermost end of the light source 1010 (i.e., the outermost end of the heat sink 1011G in FIG. 25) and the optical axis C₂ of the projection optics 1110 is approximately the same as that between the outermost end of the turning mirror 1051 and the optical axis C₂ of the projection optics 1110.

With such configuration, the projection optics 1110 is arranged in approximately the middle of the housing 1200 in a horizontal direction (the direction C shown in FIG. 25) approximately perpendicular to the optical axis C₂ of the projection optics 1110.

### Advantageous Effects

In the second embodiment, the turning mirror 1051 is aligned with the projection optics 1110 in a horizontal direction approximately perpendicular to the optical axis C₂ of the projection optics 1110. Therefore, in a horizontal direction approximately perpendicular to the optical axis C₂ of the projection optics 1110, the distance between the outermost end of the light source 1010 and the optical axis C₂ of the projection optics 1110 can be made approximately the same as that between the outermost end of the turning mirror 1051 and the optical axis C₂ of the projection optics 1110. In other words, the projection optics 1110 can be arranged in approximately the middle of the housing 1200 in a horizontal direction approximately perpendicular to the optical axis of the projection optics 1110.

As in the second embodiment, in the projection display apparatus 100 whose distance from the projection area 1400 is extremely short, the size of the projection optics 1110 is larger than that of the conventional one. In the second embodiment, the light source 1010 and the turning mirror 1051 are arranged by effectively using the dead space created in the housing 1200 by the projection optics 1110. Thus, it should be noted that the housing 1200 is not required to be increased in size to arrange the turning mirror 1051 even if the DMD 1070 is spaced away from the turning mirror 1051.

### Modification Example 1

In the following, Modification Example 1 of the second embodiment is described with reference to the drawings. In the following, the aspects of the Modification Example 1 which differ from those of the second embodiment are mainly described. Specifically, in Modification Example 1, the configuration of the projection optics 1110 differs from that in the second embodiment.

### Optical Configuration of Projection Display Apparatus

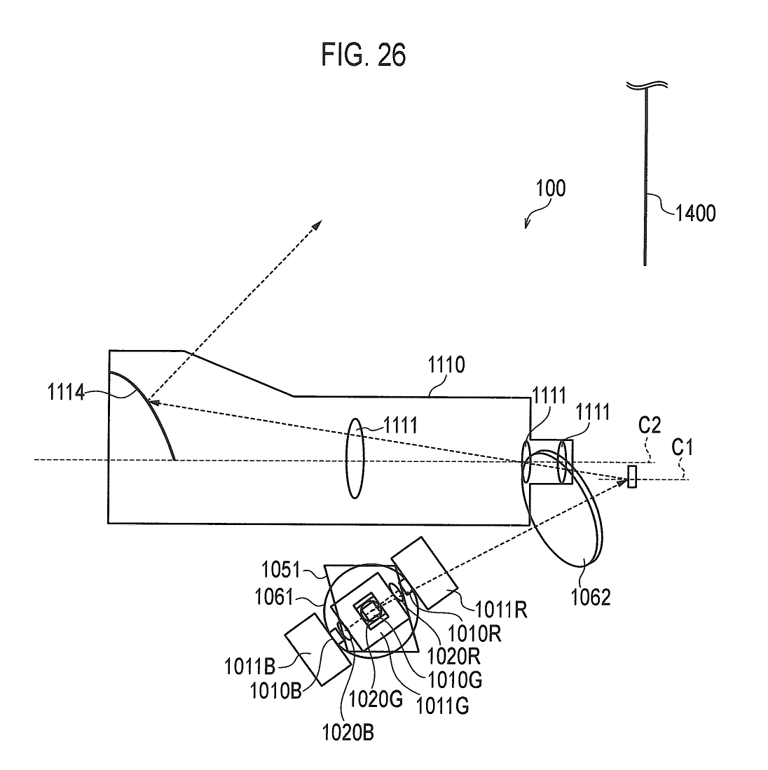

In the following, the optical configuration of a projection display apparatus according to Modification Example 1 is described with reference to the drawings. FIG. 26 is a diagram showing the optical configuration of the projection display apparatus 100 according to the second embodiment. FIG. 26 is a diagram of the projection display apparatus 100 as viewed from the direction A shown in FIG. 21. Also, in FIG. 26, similar components to those in FIG. 24 are labeled with the same reference numerals as in FIG. 24.

As shown in FIG. 26, the projection optics 1110 has a reflection mirror 1114 instead of the reflection mirror 1112 and the reflection mirror 1113.

The reflection mirror 1114 reflects the color component light (image light) incident from the projection lens group 1111. The reflection mirror 1114 does not collect the image light, but enlarges the image light. For example, the reflection mirror 1114 is a non-spherical mirror having its convex surface on a side closer to the projection lens group 1111. Here, the reflection mirror 1112 has a shape formed by a portion of an approximately circular shape with its center on the optical axis C₂ of the projection optics 1110 (for example, an upper half semi-circle).

It should be noted that the center of the DMD 1070 is shifted from the optical axis of the projection optics 1110 (i.e., the center of the lenses provided in the projection optics 1110) in Modification Example 1. Specifically, as shown in FIG. 26, the center C₁ of the DMD 1070 is shifted from the optical axis center C₂ of the projection optics 1110 toward the first opposed wall 1210 (the opposite side of the projection optics 1110 from the projection area 1400).

### Advantageous Effects

In Modification Example 1, similar effects to those in the second embodiment can be obtained even if the configuration of the projection optics 1110 differs from that in the second embodiment. That is to say, similar effects to those in the second embodiment can be obtained even if the projection optics 1110 has a non-spherical mirror with a convex surface.

### Modification Example 2

In the following, Modification Example 2 of the second embodiment is described with reference to the drawings. In the following, the aspects of the Modification Example 2 which differ from those of the second embodiment are mainly described. Specifically, in Modification Example 1, the configuration of the projection optics 1110 differs from that in the second embodiment.

### Optical Configuration of Projection Display Apparatus

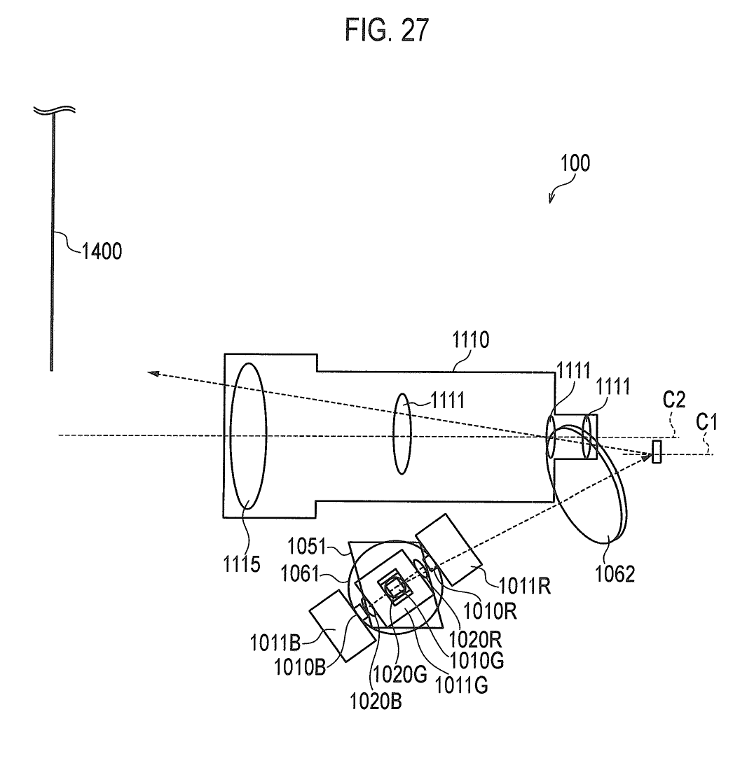

In the following, the optical configuration of a projection display apparatus according to Modification Example 2 is described with reference to the drawings. FIG. 27 is a diagram showing the optical configuration of the projection display apparatus 100 according to the second embodiment. FIG. 27 is a diagram of the projection display apparatus 100 as viewed from the direction A shown in FIG. 21. Also, in FIG. 27, similar components to those in FIG. 24 are labeled with the same reference numerals as in FIG. 24.

As shown in FIG. 27, the projection optics 1110 has a projection lens 1115 instead of the reflection mirror 1112 and the reflection mirror 1113.

The projection lens 1115 transmits the color component light (image light) incident from the projection lens group 1111. The projection lens 1115 does not collect the image light, but enlarges the image light.

It should be noted that the center of the DMD 1070 is shifted from the optical axis of the projection optics 1110 (i.e., the center of the lenses provided in the projection optics 1110) in Modification Example 1. Specifically, as shown in FIG. 26, the center C₁ of the DMD 1070 is shifted from the optical axis center C₂ of the projection optics 1110 toward the first opposed wall 1210 (the opposite side of the projection optics 1110 from the projection area 1400).

### Advantageous Effects

In Modification Example 2, similar effects to those in the second embodiment can be obtained even if the configuration of the projection optics 1110 differs from that in the second embodiment. That is to say, similar effects to those in the second embodiment can be obtained even in using the projection optics 1110 of front projection.

### Modification Example 3

In the following, Modification Example 3 of the second embodiment is described with reference to the drawings. In the following, the aspects of the Modification Example 3 which differ from those of the second embodiment are mainly described. Specifically, in Modification Example 3, the arrangement of the projection optics 1110 differs from that in the second embodiment.

### Optical Configuration of Projection Display Apparatus

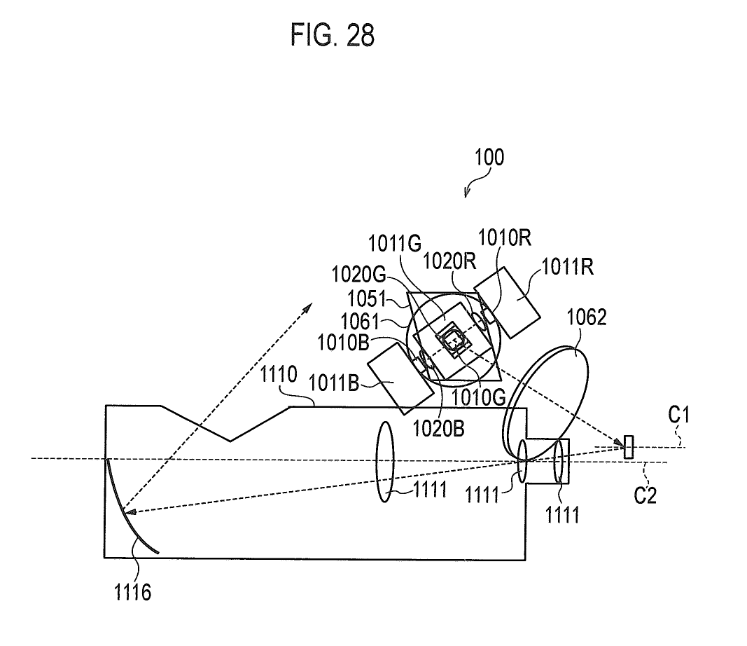

In the following, the optical configuration of a projection display apparatus according to Modification Example 3 is described with reference to the drawings. FIG. 28 is a diagram showing the optical configuration of the projection display apparatus 100 according to the second embodiment. FIG. 28 is a diagram of the projection display apparatus 100 as viewed from the direction A shown in FIG. 21. Also, in FIG. 28, similar components to those in FIG. 24 are labeled with the same reference numerals as in FIG. 24.

In Modification Example 3, as shown in FIG. 28, the light source 1010 is arranged on the top plate 1260 side (the projection area 1400 side) of the optical axis center C₂ of the projection optics 1110. Also, it should be noted that the center of the DMD 1070 is shifted from the optical axis of the projection optics 1110 (i.e., the center of the lenses provided in the projection optics 1110). Specifically, as shown in FIG. 28, the center C₁ of the DMD 1070 is shifted from the optical axis center C₂ of the projection optics 1110 toward the top plate 1260 (toward the projection area 1400).

Also, as shown in FIG. 28, the projection optics 1110 has a reflection mirror 1116 instead of the reflection mirror 1112 and the reflection mirror 1113.

The reflection mirror 1116 reflects the color component light (image lights) incident from the projection lens group 1111. The reflection mirror 1116 does not collect the image light, but enlarges the image light. For example, the reflection mirror 1116 is a non-spherical mirror having its convex surface on a side closer to the projection lens group 1111. Here, the reflection mirror 1116 has a shape formed by a portion of an approximately circular shape with its center on the optical axis C₂ of the projection optics 1110 (for example, an upper half semi-circle).

### Advantageous Effects

In Modification Example 3, similar effects to those in the second embodiment can be obtained even if the configuration of the projection optics 1110 and the arrangement of the light source 1010 differ from that in the second embodiment. That is to say, similar effects to those in the second embodiment can be obtained even if the light source 1010 is arranged on the top plate 1260 side (the projection area 1400 side) of the optical axis center C₂ of the projection optics 1110.

### Other Embodiments

The present invention has been described using the above embodiments; however, it should not be understood that the description and drawings which constitute part of this disclosure limit the present invention. From this disclosure, various alternative embodiments, examples, and operation techniques will be easily found by those skilled in the art.

In the embodiments, a DMD (Digital Micromirror Device) only has been illustrated as an imager. The imager may be a reflection type liquid crystal panel.

In the embodiments, for an arrangement of specific optical elements, the illustrated case uses a space provided below the projection optics 110 out of the dead space (the second layout space 320) created by an arrangement of the projection optics 110. However, the embodiments are not limited to this case. Specifically, the specific optical elements may be arranged in a space provided at the side of the projection optics 110 out of the dead space (the second layout space 320) created by an arrangement of the projection optics 110. Otherwise, the specific optical elements may be arranged in a space provided above the projection optics 110 out of the dead space (the second layout space 320) created by an arrangement of the projection optics 110.

In the embodiments, a case has been illustrated where the illumination optics 510 and the cooler 520 are arranged above and below the projection optics 540, respectively. However, the embodiments are not limited to this case. For example, the illumination optics 510 and the cooler 520 may be arranged in the left and right sides of the projection optics 540, respectively. Also, in this case, at least a portion of the illumination optics 510 is preferably arranged in the second layout space 320 described above. Similarly, at least a portion of the cooler 520 is preferably arranged in the second layout space 320 described above.

Japanese Patent Application No. 2009-272485 (filed on Nov. 30, 2009), Japanese Patent Application No. 2010-225698 (filed on Oct. 5, 2010), and Japanese Patent Application No. 2010-075308 (filed on Mar. 29, 2009), which are hereby incorporated by reference in their entireties.

### INDUSTRIAL APPLICABILITY

According to the present invention, a projection display apparatus which allows its illumination optics and projection optics to be arranged in a space-saving manner may be provided.

1. A projection display apparatus including a housing configured to house an illumination optics and a projection optics, wherein
the housing includes a virtual cylindrical layout space having as a base a circumscribed circle of the projection optics in a cross-section perpendicular to an optical axis of the projection optics,
the layout space includes a first layout space of approximately conical shape and a second layout space left after excluding the first layout space,
the projection optics is provided in the first layout space, and
a specific optical element among optical elements included in the illumination optics is provided in the second layout space.

2. The projection display apparatus according to claim 1, wherein
the specific optical element is an optical uniformizing element, and
an optical axis of the optical uniformizing element is parallel to an optical axis of the projection optics.

3. The projection display apparatus according to claim 1, wherein
the specific optical element is an optical uniformizing element, and
in a positional relationship, an optical axis of the optical uniformizing element is skewed toward an optical axis of the projection optics.

4. The projection display apparatus according to claim 1, wherein
the projection optics includes a first lens group, a second lens group having a bigger diameter than the first lens group, and a reflection mirror configured to reflect a light incident from the second lens group toward a projection surface, and
a light source included in the illumination optics is provided between the second lens group and the reflection mirror.

5. The projection display apparatus according to claim 1, wherein
a light source included in the illumination optics is provided at a side of a lens group provided in the projection optics.

6. A projection display apparatus including a housing configured to house an illumination optics and a projection optics, wherein
the illumination optics includes a light source, a mirror configured to reflect a light emitted from the light source, and an imager configured to modulate a light reflected by the mirror,
the mirror is aligned with the projection optics in a horizontal direction approximately perpendicular to an optical axis of the projection optics, and
in the horizontal direction approximately perpendicular to the optical axis of the projection optics, a distance between an outermost end of the light source and the optical axis of the projection optics is approximately equal to a distance between an outermost end of the mirror and the optical axis of the projection optics.

7. The projection display apparatus according to claim 6, wherein
the projection optics includes a reflection mirror configured to reflect a light emitted from the illumination optics toward a projection area.

8. The projection display apparatus according to claim 7, wherein
the reflection mirror is a plane mirror or a concave mirror, and
the imager is arranged at a position shifted toward an opposite side of the optical axis of the projection optics from the projection area.

9. The projection display apparatus according to claim 7, wherein
the reflection mirror is a convex mirror, and
the imager is arranged at a position shifted toward an opposite side of the optical axis of the projection optics from the projection area.

10. The projection display apparatus according to claim 7, wherein
the reflection mirror is a concave mirror, and
the imager is arranged at a position shifted toward an opposite side of the optical axis of the projection optics from the projection area.
